(19) United States
(12) Patent Application Publication
(10) Pub. No.: US 2026/0064543 A1
(43) Pub. Date: Mar. 5, 2026

(54) Backing up a database in multiple parts to multiple locations to improve timing

(71) Applicant: DigiCert, Inc., Lehi, UT (US)

(72) Inventors: Wendell Porter, Alpine, UT (US); Avesta Hojjati, Austin, TX (US)

(73) Assignee: DigiCert, Inc., Lehi, UT (US)

(21) Appl. No.: 18/816,016

(22) Filed: Aug. 27, 2024

(51) Int. Cl. G06F 11/14; G06F 11/10; G06F 16/21; G06F 16/27

(52) U.S. Cl. CPC G06F 11/1466; G06F 11/1096; G06F 11/1451; G06F 11/1464; G06F 16/211; G06F 16/27; G06F 2201/80

(57) ABSTRACT

Systems and methods for backing up a database are provided. A method, according to one implementation, includes a step of receiving a command to perform a full backup procedure in which data stored in a database is intended to be backed up. The method further includes a step of detecting physical locations that are available for data storage. Based on the detected physical locations and a data distribution plan, the method further includes a step of dividing the data stored in the database into multiple data sections and distributing the multiple data sections to corresponding physical locations.

### FIELD OF THE DISCLOSURE

The present disclosure relates generally to computer networking systems. More particularly, the present disclosure relates to systems and methods for backing up the data from a single database in multiple parts to multiple logical or physical drives at one or more locations, with the objective of improving completion time.

### BACKGROUND

The procedure for backing up a large database can often involve careful planning and execution in order to ensure the integrity of important data and to minimize downtime. One strategy, for example, may include performing a “full” backup procedure once every week or so and then performing “incremental” or “differential” backup procedures every day or so based on changes in the data from the time of the full backup. Having access to backup copies of this important data allows an organization to continue running business, even in the event of disasters, such as fires, cyber-attacks, or other types of catastrophes that can destroy the databases and/or the data files stored therein. As such, after a disaster, Disaster Recovery (DR) may then be used to recover the lost data. FIG. 1 is a diagram showing a system 10 using a conventional data backup procedure. As shown, the typical strategy allows a user to choose a source database 12, which stores the original data to be backed up, and to choose a destination database 14, which is meant to store a redundant backup copy of the data. Thus, after performing the backup procedure, the data is stored on each of the two separate databases 12, 14. In a DR situation, when timing may be critical, the process of backing up the source database 12 to the destination database 14 may take hours, critically time that may be too long.

### BRIEF SUMMARY

The present disclosure relates to systems and methods for performing a backup procedure for backing up the data in a large database by distributing the data in multiple parts to multiple locations. According to one implementation, a method includes the step of receiving a command to perform a full backup procedure in which data stored in a database is intended to be backed up. The method further includes a step of detecting physical locations that are available for data storage. Based on the detected physical locations and a data distribution plan, the method also includes a step of dividing the data stored in the database into multiple data sections and distributing the multiple data sections to corresponding physical locations.

According to various embodiments, the method may further include a step of creating control information that is distributed to one or more of the physical locations. For example, the control information may be configured to instruct how each of the multiple data sections is to be stored and accessed. Also, in some embodiments, the method may further include a step of creating a ledger having at least a database schema for defining details regarding the data distribution plan, the data, and the full backup procedure. Furthermore, the method may also include a step of creating parity sections and distributing the parity sections to one or more of the physical locations, wherein the parity sections are configured to enable a parity check upon accessing backed up data from the physical locations.

In some embodiments, the full backup procedure may be part of routine maintenance performed by a Data Base Management System (DBMS) associated with the database. The full backup procedure, for instance, may result in the redundant storage of the data for at least the purpose of Disaster Recovery (DR), wherein DR may be executed in response to one or more events occurring with respect to one or more facilities associated with the multiple physical locations. For example, the one or more events may include a natural disaster, a flood, an earthquake, a tornado, a fire, a cyber-attack, vandalism, electrical-related, mechanical-related, and/or temperature-related issues with respect to the one or more facilities.

The multiple physical locations may include one or more data storage facilities related to a Backup as a Service (BaaS) facility, a cloud-based data backup repository, and/or an offsite facility. The step of distributing the multiple data sections to the physical locations may include storing the multiple data sections in multiple physical or logical drives. The database, for example, may be a Structured Query Language (SQL) database and/or a relational database.

According to some implementations, the multiple data sections may be distributed in a manner that is at least partially in parallel, which may thereby reduce a time to perform the full backup procedure in comparison with a procedure in which the data is distributed to a single location for storage. The data, for example, may include information and/or files at least related to digital certificates issued by a Certificate Authority (CA). Also, the database, for example, may be a Very Large Data Base (VLDS) and the data may include at least 1 terabyte (TB).

In various embodiments, the present disclosure includes a) methods having the above-mentioned steps, b) processing devices configured to implement the above-mentioned steps, c) cloud services configured to implement the above-mentioned steps, and d) non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram showing a conventional data backup procedure.

FIG. 2 is a diagram illustrating a system for backing up a database, according to various embodiments of the present disclosure.

FIG. 3 is a block diagram illustrating a computing device for distributing data from a single database to multiple physical locations, according to various embodiments of the present disclosure.

FIG. 4 is a flow diagram illustrating a method for distributing data from a database to multiple locations, according to various embodiments.

### DETAILED DESCRIPTION

Again, the present disclosure relates to systems and methods for backing up or archiving data originally stored in a large database. In particular, instead of sending a copy of the data to a single destination, as is done in conventional systems, the systems and methods of the present disclosure are configured to divide the data into multiple sections and then distribute those data sections to multiple locations, e.g., different data drives, which may be located at the same data storage facility (e.g., a single data center) or different data storage facilities (e.g., multiple data centers).

The creation of redundant copies of data may be implemented by a Data Base Management System (DBMS). With the availability of one or more extra copies of the data, an organization may continue doing business, even after disasters. These disasters, for example, may come in any form, such as natural disasters (e.g., tornadoes, floods, lightning strikes, fires, earthquakes, etc.). Also, disasters may include problems with the building or facility in which a database is housed, such as electrical issues (e.g., power loss, transients, surges, spikes, voltage fluctuations, frequency variations, noise, harmonics, improper grounding, etc.). Other building issues may be caused by leaky roofs, HVAC systems not cooling properly, etc. Some disasters may also be caused by humans, such as cyber-attacks, vandalism, arson, user error, etc. Therefore, having access to a backup copy of important data can allow an organization to perform a Disaster Recovery (DR) procedure to recover an original copy of the data and “rebuild” the original database.

### Distributed Data Backup

FIG. 2 is a diagram illustrating an embodiment of a system 20 for backing up (or archiving) a database 22. In some embodiments, the system 20 may be a Data Base Management System (DBMS) or may be associated with a DBMS. The database 22 may be a Structured Query Language (SQL) server database, a relational database, or other suitable type of database. The system 20 may include a management device 23 configured to manage the various operations thereof.

The system 20 is configured to obtain a full copy of the data from the database 22 and pass it to a data dividing module 24. The data dividing module 24 is configured to divide the data into a plurality of data sections (e.g., six sections, eight sections, ten sections, twelve sections, etc.) based on the availability of storage drives where redundant copies of data may be stored.

Furthermore, the system 20 includes a control information creating module 26, which may operate along with the data dividing module 24. The control information creating module 26 may be configured to create control or management information (e.g., header) that includes information regarding the dividing of the data into sections. The data may be separated into data blocks and may be based on the sizes of various data files. Also, the control info may define what each data section contains, where each data section is to be stored, the size of each data section, the type of backup procedure being performed (e.g., full backup, incremental backup, differential backup, etc.), when the backup procedure is performed, and/or other information for defining the backup procedures.

Next, the system 20 includes a data/control distributing module 28, which is configured to distribute the data sections along with the control information to a plurality of data drives 30 (e.g., Hard Disk Drives (HDDs), hard drives, Solid State Drives (SSDs), flash drives, pen drive, thumb drive, memory stick, SD card, etc.). In some implementations, the control information may be distributed to each of the data drives 30.

In some embodiments, recovery of the data stored in the multiple data drives 30 may include retrieving the data from each of the respective data drives 30. This may be done based on details in the control/header information. When the data is retrieved, the system 20 may rejoin the data sections to obtain a full copy of the original data, which can then be used as needed (e.g., to replace an original copy during a DR operation).

According to various embodiments, the management device 23 may enable a user to enter backup plans for automatically scheduling full backup procedures, incremental backup procedures, differential backup procedures, etc. Also, the user may input Recovery Point Objectives (RPO) and Recovery Time Objectives (RTO) for plan various backup strategies. As such, the user (e.g., administrator, network operator, IT personnel, etc.) may determine the frequency of backups (e.g., daily, weekly, etc.) and the type of backups (e.g., full, incremental, differential) based on the RPO and RTO. RPO may be defined as the maximum allowable amount of data (within a certain amount of time) that could be lost after a DR before the data loss exceeds a tolerable level for the organization. In some cases, no amount of data loss would be acceptable and the RPO may be set to “zero.” RTO may be defined as the maximum acceptable time that an application, computer, network, or system can be down after an unexpected disaster takes place.

A full backup of a large database can require terabytes of storage space in the data drives 30. For some organizations, it may be advisable to back up a month's worth of data, but this can be expensive and unnecessary. For example, if the organization is a Certificate Authority (CA) (e.g., DigiCert) and stores digital certificates for multiple clients, the CA may wish to utilize the strictest rules where backup is scheduled frequently and the RPO and RTO ensure extremely secure and comprehensive backup policies. On the other hand, some organizations may not require strict backup policies and can tolerate a greater amount of loss and/or a longer recovery time without any effect on the organization's bottom line.

The system 20 of FIG. 2 may be a DBMS that is arranged on-site with an organization's databases. In other embodiments, the system 20 may be a cloud-based system, a Backup as a Service (BaaS) server, etc., and may be housed in one or more facilities. The system 20 is configured to prepare the data drives 30 in the one or more facilities (e.g., one or more data centers) for storing data. The management device 23 may allocate sufficient storage space for the various backup storage needs for storing the backup files for the organization or for one or more clients in a third-party role.

The user and/or client may schedule a backup window for each of the various backup procedures (e.g., full, incremental, differential, etc.) to be performed. For example, the planned backup procedures may be scheduled during off-peak hours to minimize the impact on database performance and user activity and to ensure minimal disruption to business operations.

A “full” backup procedure may include backing up (archiving) the entire database 22. This may include copying all the data files, transaction logs, and other relevant files associated with the database 22 to the backup destinations (e.g., data drives 30). After a full backup, the management device 23 may allow a user to schedule “incremental” backup procedures as well. An incremental backup includes capturing only the data that has changed since the last full backup or the last incremental backup. During an incremental backup, the management device 23 is configured to scan the database 22 for changes since the last backup and copy only the modified data blocks or files. In some embodiments, these changes may be divided by the data dividing module 24 and distributed by the data/control distributing module 26 to one or more data drives 30. In other embodiments, since each incremental change may be may small compared with the full backup, the management device 23 may store the incremental change in whole in a single data drive 30. A “differential” backup is configured to capture all the data that has changed since the last full backup. Unlike an incremental backup, which only captures changes since the last backup (e.g., full or incremental), a differential backup captures changes since the last “full” backup.

Incremental and differential backups are typically smaller in size compared to full backups since they only include the changed data within a relatively short amount of time. This can save storage space in the data drives 30 and reduce backup time. Also, during a recovery process (e.g., DR), the management device 23 can first recover the last full backup from the data drives 30 (using the control information). Then, the incremental or differential backups can be applied to obtain the most recent state of the data.

Furthermore, after performing the various backup procedures, the system 20 may be configured to verify that the procedures are complete. The system 20 may verify the integrity and completeness of the backup files. For example, the system 20 may perform validation checks to ensure that all necessary data has been successfully backed up.

Since the data drives may be located off-premises at third-party storage facilities, such as cloud storage services, the data/control distributing module 28 may be configured to include encryption techniques to ensure the data includes encrypted backup files during transit over public networks and while stored in cloud service facilities, particularly since the facilities may include multiple locations (e.g., in the same data center or in data centers in remote cities).

Also, the system 20 may be configured to perform various backup tests to check the backup covers and restoration capabilities. The system 20 can regularly test backup and restore procedures to validate their effectiveness. Also, the system 20 may simulate various disaster scenarios to ensure that data can be recovered within the required RPO and RTO parameters. The system 20 may periodically review and update the backup strategies as needed to accommodate changes in data volume, business requirements, and technology advancements.

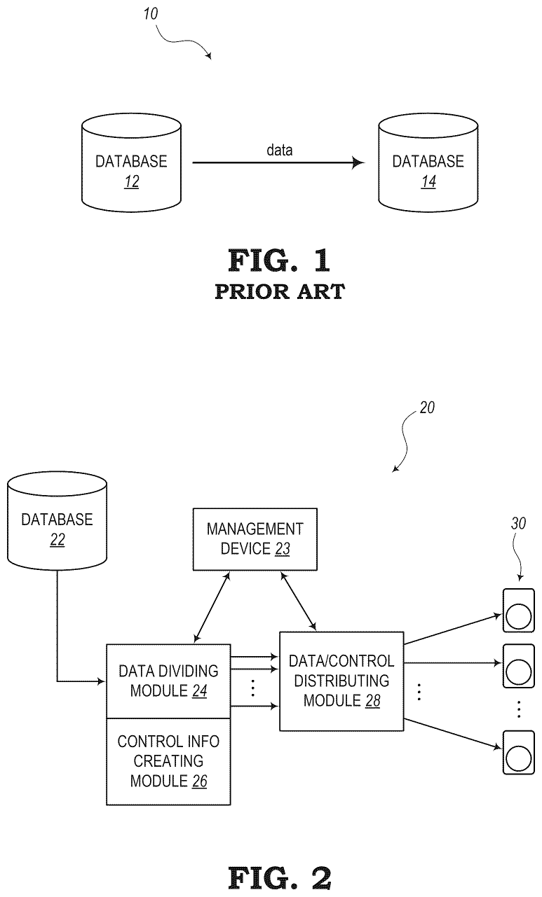

In conventional systems, such as the embodiment of FIG. 1, a large database can take a long time to back up. Therefore, the systems and methods of the present disclosure are configured to reduce the backup time. That is, by dividing the data into sections, the data can then be distributed to the multiple data drives 30 in a substantially parallel manner. Hence, the system 20 can back up portions of the database 22 to the multiple locations at the same time or during the same backup session. This will thereby reduce the time it takes to perform the backup.

After a disaster related to the database 22, the system 20 can run a DR procedure to recover lost data. According to one example, suppose the database 22 stores 4 TB of data. Normally (e.g., FIG. 1), it might take hours to fully back up the data to a single site. Therefore, by backing up the database 22 to multiple sites, as described in the present disclosure, each site would not necessarily receive a full copy of the whole database, but instead would receive one data section, as divided by the data dividing module 24. The system 20 can then perform the backup procedure quickly. This may be performed on a routine basis for regular database maintenance and/or may be performed in the event of a possible impending disaster.

As an analogy, the data drives 30 may be considered to be a set of physical drives that can be set up to act as a single logical drive. When a file is written to that logical drive, blocks of the data can be written to different physical drives within the single logical drive. According to the implementations of the present disclosure, the multiple physical or logical drives can be set up for the database 22, and the system 20 can back up portions to each of the data drives 30. Again, the management device 23 may be configured to analyze the status of the data drives 30 to determine which ones are available to receive new backup data and to be accessible for restoration, when needed.

### Control Information

The control information creating module 26 may be configured to create management and/or control information that may be used to define how the data is divided, how to put it back together, the general contents of each data section, when the data was backed up, and/or any other information related to the splitting and distributing of data from a single source database to multiple destination databases. For example, in some embodiments, the control information may include a ledger that defines a database schema. The control information may also include parity bits for allowing parity checks.

### Ledger:

According to some embodiments, the control information may include a ledger, record, or register regarding details of the data. These details may include a) when the data was first created and stored, b) when the data was modified, c) who created or modified the data, d) specifics of the source database, e) specifics of the actions of splitting the data into sections for backup purposes, and/or other information. The ledger may be a private ledger that is not shared outside of the realm of the backup system.

The ledger may include a database schema that is configured to define the structure of a database and may be described in a language supported by a Relational Data Base Management System (RDBMS). The database schema may be configured as a blueprint that organizes data and describes how the database is constructed (e.g., divided into tables in the case of a relational database). The database schema may include a set of “integrity constraints” imposed on a database to ensure compatibility among different parts of the system. The database schema may include a mapping or model of the database. With respect to a relational database, the schema may define the tables, fields, relationships, views, indexes, packages, procedures, functions, queues, triggers, types, sequences, materialized views, synonyms, database links, directories, XML schemas, and the like.

In some embodiments, the ledger may be configured to hold the schema of the database, which may be distributed to one or more of the data drives 30. During each backup session, the system 20 may be configured to generate a new block with the location of the backed-up data. For example, the location could be a data center, Network-Attached Storage (NAS) devices within the data center, or any other defined path which could later be used for the sake of recovery. A NAS device may be configured to perform file-level data storage, as opposed to block-level data storage. NAS systems may be networked elements that contain one or more storage drives, often arranged into logical, redundant storage containers or RAID. The location could also include multiple locations distributed across the globe.

During the recovery mode, a client may look at the ledger to 1) request a specific table, 2) find the location of that table given that the data has been backed up in a distributed way, 3) access that location and download the proper table, and 4) rebuild the database using instructions available in the ledger. In some embodiments, the ledger may be stored in a block (e.g., using a blockchain technique), which can be distributed and stored in one or more locations (e.g., multiple data drives 30, multiple data centers, etc.).

### Parity Bits:

In some embodiments, the control information creating module 26 may be configured to add parity bits, which can be stored with the data sections in one or more locations. According to one example, one parity bit may be calculated for each four bits (i.e., nibble) or eight bits (i.e., byte) of data. The parity bits may be combined in a data block and stored together in a predetermined manner.

According to various implementations, the data dividing module 24 may be configured to split the data from the database 22 into a plurality of data sections (e.g., data blocks, data portions, etc.) plus a plurality of parity sections (e.g., parity blocks, parity portions, etc.). In one example, the data dividing module 24 and control information creating module 26 may work together to form nine data sections and three parity sections for a total of 12 total sections. Then, these 12 sections can be distributed to 12 different data drives 30.

Parity can be used to restore data from the data drives 30 even if one or two of the data drives 30 fails. Similar to other parity checks, a parity bit is an indication of an even number or odd number of 1 bits in the corresponding data bits. Then, when reconstructing the data from the data drives 30, the parity bit can be checked to see if any of the data bits are corrupted or lost. This may be similar to a Redundant Array of Independent Disks (RAID) technique, such as RAID 5, RAID 6, etc., in which data is stored with redundancy.

### Computing Device

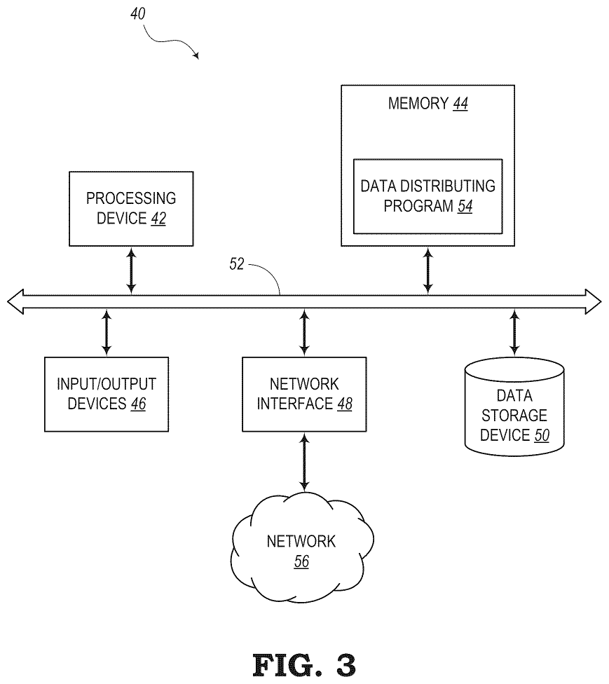

FIG. 3 is a block diagram illustrating an embodiment of a computing device 40 for distributing data from a single database to multiple physical locations. For example, the computing device 40 may represent the system 20, management device 23, a third-party BaaS server, a CA, and/or other network elements for providing backup storage services for an organization. The computing device 40 may be arranged on-premises for an organization and/or may be arranged in the cloud and may serve multiple clients. Also, the computing device 40 may be arranged in multiple locations for providing distributed storage capabilities to thereby reduce the risk of data loss based on a catastrophe occurring at a single facility, campus, or area.

The computing device 40 may be a digital computer that, in terms of hardware architecture, generally includes a processing device 42, a memory 44, input/output (I/O) devices 46, a network interface 48, and a data storage device 50. For example, the data storage device 50, according to some embodiments, may be unrelated to a source database that stores data to be backed up or one or more destination databases where backup data is to be stored.

It should be appreciated by those of ordinary skill in the art that FIG. 3 depicts the computing device 40 in an oversimplified manner, and a practical embodiment may include additional components and suitably configured processing logic to support known or conventional operating features that are not described in detail herein. The components (42, 44, 46, 48, 50) are communicatively coupled via a local interface 52. The local interface 52 may be, for example, but not limited to, one or more buses or other wired or wireless connections, as is known in the art. The local interface 52 may have additional elements, which are omitted for simplicity, such as controllers, buffers (caches), drivers, repeaters, and receivers, among many others, to enable communications. Further, the local interface 52 may include address, control, and/or data connections to enable appropriate communications among the aforementioned components.

The processing device 42 is a hardware device for executing software instructions. The processing device 42 may be any custom made or commercially available processor, a Central Processing Unit (CPU), an auxiliary processor among several processors associated with the computing device 40, a semiconductor-based microprocessor (in the form of a microchip or chipset), or generally any device for executing software instructions. When the computing device 40 is in operation, the processing device 42 is configured to execute software stored within the memory 44, to communicate data to and from the memory 44, and to generally control operations of the computing device 40 pursuant to the software instructions. The I/O devices 46 may be used to receive user input from and/or for providing system output to one or more devices or components.

The network interface 48 may be used to enable the computing device 40 to communicate on a network, such as the Internet. The network interface 48 may include, for example, an Ethernet card or adapter or a Wireless Local Area Network (WLAN) card or adapter. The network interface 48 may include address, control, and/or data connections to enable appropriate communications on the network. A data storage device 50 (e.g., one or more databases, data stores, etc.) may be used to store data. The data storage device 50 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 50 may incorporate electronic, magnetic, optical, and/or other types of storage media. In one example, the data storage device 50 may be located internal to the computing device 40, such as, for example, an internal hard drive connected to the local interface 52 in the computing device 40. Additionally, in another embodiment, the data storage device 50 may be located external to the computing device 40 such as, for example, an external hard drive connected to the I/O devices 46 (e.g., SCSI or USB connection). In a further embodiment, the data storage device 50 may be connected to the computing device 40 through a network, such as, for example, a network-attached file server.

The memory 44 may include volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 44 may incorporate electronic, magnetic, optical, and/or other types of storage media. Note that the memory 44 may have a distributed architecture, where various components are situated remotely from one another but can be accessed by the processing device 42. The software in memory 44 may include one or more software programs, each of which includes an ordered listing of executable instructions for implementing logical functions. The software in the memory 44 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing device 40 further includes a data distributing program 54 that may be implemented in any suitable combination of hardware (e.g., configured in the processing device 42) and/or software/firmware (e.g., configured in the memory 44). The data distributing program 54 may be stored in any suitable non-transitory computer-readable media (e.g., the memory 44) and may include computer logic or code having instructions that enable or cause the processing device 42 to perform certain actions as discussed in the present disclosure.

The data distributing program 54 may be configured to include steps of receiving a command to perform a full backup procedure in which data stored in a database is intended to be backed up. The data distributing program 54 is also configured to detect physical locations that are available for data storage, which may be based on the detected physical locations (e.g., data drives 30) and a data distribution plan. Also, the data distributing program 54 may be configured to divide the data stored in the database into multiple portions and distributing the multiple portions to corresponding physical locations.

Of note, the general architecture of the computing device 40 can define any device described herein. However, the computing device 40 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

The computing device 40 is configured to provide data backup services for a database, which may be on-site or off-site according to various embodiments. The computing device 40 is configured to perform a full backup procedure on a large database in a shorter amount of time than conventional systems. The reduced time can be achieved by splitting the data up into multiple segments (e.g., blocks) and distributing the segments to multiple data drives, which may be located in one single facility or in multiple facilities. Thus, in one backup session, the data segments can be distributed simultaneously to different data drives, which can reduce backup time. In some embodiments, each data segment may correspond in a one-to-one fashion with a single data drive.

For example, according to some embodiments, suppose that 4 TB of data is divided into eight sections (units, blocks, etc.), where each section includes about 500 GB of data. By distributing the 500 GB of data to eight different data drives, the backup time may be reduced by about one-eighth. Thus, if backing up to a single destination database takes about four hours, for instance, the strategy of the present disclosure may reduce that time down to about 30 minutes.

### Data Distribution and Storage Method

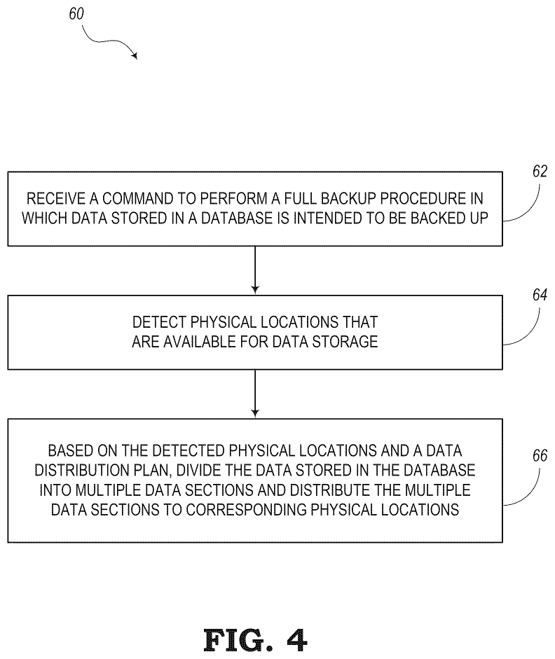

FIG. 4 is a flow diagram illustrating an embodiment of a method 60 for distributing data from a database to multiple locations. As shown in FIG. 4, the method 60 includes a step of receiving a command to perform a full backup procedure in which data stored in a database is intended to be backed up, as indicated in block 62. The method 60 further includes a step of detecting physical locations that are available for data storage, as indicated in block 64. Based on the detected physical locations and a data distribution plan, the method 60 also includes a step of dividing the data stored in the database into multiple data sections and distributing the multiple data sections to corresponding physical locations, as indicated in block 66.

According to various embodiments, the method 60 may further include a step of creating control information that is distributed to one or more of the physical locations. For example, the control information may be configured to instruct how each of the multiple data sections is to be stored and accessed. Also, in some embodiments, the method 60 may further include a step of creating a ledger having at least a database schema for defining details regarding the data distribution plan, the data, and the full backup procedure. Furthermore, the method 60 may also include a step of creating parity sections and distributing the parity sections to one or more of the physical locations, wherein the parity sections are configured to enable a parity check upon accessing backed up data from the physical locations.

In some embodiments, the full backup procedure may be part of routine maintenance performed by a Data Base Management System (DBMS) associated with the database. The full backup procedure, for instance, may result in the redundant storage of the data for at least the purpose of Disaster Recovery (DR), wherein DR may be executed in response to one or more events occurring with respect to one or more facilities associated with the multiple physical locations. For example, the one or more events may include a natural disaster, a flood, an earthquake, a tornado, a fire, a cyber-attack, vandalism, electrical-related, mechanical-related, and/or temperature-related issues with respect to the one or more facilities.

The multiple physical locations may include one or more data storage facilities related to a Backup as a Service (BaaS) facility, a cloud-based data backup repository, and/or an offsite facility. The step of distributing the multiple data sections to the physical locations (block 66) may include storing the multiple data sections in multiple physical or logical drives. The database, for example, may be a Structured Query Language (SQL) database and/or a relational database.

According to some implementations, the multiple data sections may be distributed in a manner that is at least partially in parallel, which may thereby reduce a time to perform the full backup procedure in comparison with a procedure in which the data is distributed to a single location for storage. The data, for example, may include information and/or files at least related to digital certificates issued by a Certificate Authority (CA). Also, the database, for example, may be a Very Large Data Base (VLDS) and the data may include at least 1 terabyte (TB).

### Additional Considerations

Therefore, the present disclosure describes systems and methods for backing up a database to multiple locations. Some databases may have their own specific proprietary methods of doing backup. However, in some cases, such as with the Microsoft SQL Server database, backing up data may be performed according to the methods described herein. For example, with about 4 TB of data in a database to be backed up, the actions of moving and restoring data, during DR, can normally take hours. However, with the embodiments described herein, data can be moved in parallel to multiple locations (e.g., multiple data drives at one or more data storage facilities).

When a user wants to perform a backup with many conventional systems (e.g., through a SQL server), the user only has one option with respect to the destination of the data. The conventional system then simply transfers the data in a serial manner, as shown in FIG. 1. However, by using the embodiments described in the present disclosure, a user can choose multiple locations where data is stored, whereas, in other embodiments, the multiple locations can be selected automatically. Thus, by writing the data to multiple locations, the systems described herein can determine the various formats of the data drives 30 and can distribute one data section to each of the selected data drives 30 based on the various formats and configurations thereof. Thus, the time can be reduced drastically by streaming data from a single spinning disk (spindle) to multiple spinning disks at the same time.

Each data drive 30 may include a disk array controller that is configured to present the corresponding data drive to a computer as a logical unit. The data array controller may implement hardware RAID and may therefore be referred to as RAID controller. It may also provide additional disk cache and may be configured to manage internal disk drive operations.

The data dividing module 24 may be configured to figure out what data section goes where. The data dividing module 24 can take the entirety of the database 22 and split it up into multiple pieces. Also, with the control information creating module 26, the data dividing module 24 can create parity segments of the data as well. In one example, the system 20 can take the data, split it up into nine data pieces and three parity pieces, giving a total of 12 pieces, each being about the same size (e.g., about the same number of bits). In this case, the storage space is increased by a third. Then, during reconstruction of the data from the multiple data drives 30, any nine or ten of the 12 pieces can be used to reconstruct the data. In other words, with the added redundancy, it is possible to lose any two or three pieces and still be able to reconstruct the original data. This includes Forward Error Correction (FEC), such as Reed-Solomon.

The system is configured to back up the database 22 in a distributed fashion, which may be done using private ledgers. Thinking about this as a distributed model with a private ledger, there may be no difference between any ledger and any databases if they are distributed. One difference in this case, however, is that it can be either quorum-based or orchestrator-based and may be capable of figuring out where the blocks of data are, when the data is rebuilt, and so on. In the example of nine data pieces and three parity pieces, the ledger may be configured to keep track of where each of those 12 pieces are. This can solve a problem for some enterprise approaches, especially if they deal with SQL, for example, where there is one centralized ledger, in a sense, that tells the user where the data is located. It could be in a specific table in a specific database in a data center in Arizona, for instance.

When data is distributed to multiple different tables in multiple drives in multiple data centers, reversing the process may involve the system 20. However, in other embodiments, it is possible that the data drives 30, which may be associated with different nodes, to utilize information in the ledger to communicate with one another to reconstruct the data without the need for the system that originally divided the data. Therefore, in the reversing or reconstruction process, the nodes can reach out to each other to determine reconstruction information that may be stored in the ledger.

In this case, an operator at one peripheral node (e.g., associated with one or more of the data drives 30) may have a need to recover lost data. In some cases, it may not be possible to go back to the original dividing entity (e.g., system 20), which may also be out of commission. Instead, by knowing what portions of the data are where, as retrieved from the ledger, the operator can access other nodes directly or indirectly, depending on the various links between nodes. In this way, the operator can retrieve data sections from one or more other databases at one or more other peripheral nodes, as available, to reconstruct the data. In some respects, this configuration may be considered to be a system without a centralized master or orchestrator node, but instead is configured as a mesh-type network where any node can access data from another node via any viable path.

This is where the ledger comes into play. The control information creating module 26 may be configured to basically create a hash table in the information (header). This may relate to a node, where each one of the addresses not only includes the data, but also the control information for defining the various details about how the data was divided and how it can be put back together. The control information can also define where each data portion and parity portion is stored, whether they are stored in the same node or one or more different nodes. Furthermore, the control information can define the location within the nodes (e.g., specific databases, drives, etc.) as well as the location within each database or drive (e.g., specific tables, etc.). Again, even if one or two pieces are unavailable, due to portions of a network being inaccessible or faulty (e.g., one or more databases going down), it is still possible to utilize the remaining pieces to reconstruct the entire dataset. By knowing where all the data is, it is possible for an operator to rebuild or reconstruct the database.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

1. A system comprising:
a processing device; and
memory configured to store computer logic having instructions that, when executed, enable the processing device to
receive a command to perform a full backup procedure in which data stored in a structured database managed by a Data Base Management System (DBMS) is intended to be backed up,
programmatically detect, from among a plurality of physical or logical data drives located at one or more data storage facilities, those drives that are currently available for data storage by determining a storage-availability state of each drive, and
based on the detected physical locations or logical drives and a database-aware data distribution plan generated according to a database schema of the structured database, divide the data stored in the database into multiple data sections corresponding to portions of the structured database and distribute, in a manner that is at least partially in parallel, the multiple data sections to corresponding physical or logical drives to reduce a completion time of the full backup procedure.

2. The system of claim 1, wherein the instructions further enable the processing device to create control information distributed to one or more of the physical or logical drives, the control information identifying, for each data section, a storage format, location, access path, and reconstruction sequence and instructing how each of the multiple data sections is to be stored and accessed.

3. The system of claim 1, wherein the instructions further enable the processing device to create a ledger having at least a database schema for defining details regarding the data distribution plan, the data, and the full backup procedure, the ledger mapping each data section to a corresponding physical or logical drive to facilitate reconstruction of the structured database.

4. The system of claim 1, wherein the instructions further enable the processing device to create parity sections and distributing the parity sections to one or more of the physical or logical drives, the parity sections enabling a parity check during reconstruction of the structured database from distributed data sections, and
wherein detecting the drives that are available comprises determining, for each drive, one or more of: free capacity, current load, reachability, network latency, and drive-health state.

5. The system of claim 1, wherein the full backup procedure is part of routine maintenance performed by the Data Base Management System (DBMS) associated with the database.

6. The system of claim 1, wherein the full backup procedure results in redundant storage of the data for at least a purpose related to Disaster Recovery (DR), wherein DR is executed in response an occurrence of one or more events with respect to one or more facilities associated with the physical or logical drives, the one or more events including one or more of a natural disaster, a flood, an earthquake, a tornado, a fire, a cyber-attack, vandalism, electrical-related, mechanical-related, and/or temperature-related issues with respect to the one or more facilities.

7. The system of claim 1, wherein the physical or logical drives are in one or more data storage facilities related to a Backup as a Service (BaaS) facility, a cloud-based data backup repository, and/or an offsite facility.

8. The system of claim 1, wherein distributing the multiple data sections to the physical or logical drives includes storing the multiple data sections in multiple physical or logical drives.

9. The system of claim 1, wherein the database is a Structured Query Language (SQL) database and/or relational database.

10. The system of claim 1, wherein the multiple data sections are distributed for storage in a manner that is at least partially in parallel, by initiating multiple concurrent transfer sessions between the system and the physical or logical drives, thereby reducing a time to perform the full backup procedure in comparison with a procedure in which the data is distributed to a single location for storage, and
wherein distributing the data sections comprises selecting, for each section, a drive having a storage format compatible with a format of the data section.

11. The system of claim 1, wherein the data includes information and/or files at least related to digital certificates issued by a Certificate Authority (CA).

12. The system of claim 1, wherein the database is a Very Large Data Base (VLDS) and/or the data includes at least 1 TB.

13. A method comprising the steps of:
receiving a command to perform a full backup procedure in which data stored in a structured database managed by a Data Base Management System (DBMS) is intended to be backed up;
programmatically detecting from among a plurality of physical or logical data drives located at one or more data storage facilities, those drives that are available for data storage by determining a storage-availability state of each drive; and
based on the detected physical or logical drives and a database-aware data distribution plan generated according to a database schema of the structured database, dividing the data stored in the database into multiple data sections corresponding to portions of the structured database and distributing, in a manner that is at least partially in parallel, the multiple data sections to corresponding physical or logical drives to reduce a completion time of the full backup procedure.

14. The method of claim 13, further comprising the steps of:
creating control information instructing how each of the multiple data sections is to be stored and accessed; and
distributing the control information to one or more of the physical or logical drives, the control information identifying, for each data section, a storage format, location, access path, and reconstruction sequence.

15. The method of claim 13, further comprising the step of creating a ledger having at least a database schema for defining details regarding the data distribution plan, the data, and the full backup procedure, the ledger mapping each data section to a corresponding physical or logical drive to facilitate reconstruction of the structured database.

16. The method of claim 13, further comprising the steps of:
creating parity sections; and
distributing the parity sections to one or more of the physical or logical drives;
wherein the parity sections are configured to enable execution of a parity check during reconstruction of the structured database from distributed data sections, and
wherein detecting the drives that are available comprises determining, for each drive, one or more of free capacity, current load, reachability, network latency, and drive-health state.

17. The method of claim 13, wherein the full backup procedure results in redundant storage of the data for at least a purpose related to Disaster Recovery (DR), wherein DR is executed in response an occurrence of one or more events with respect to one or more facilities associated with the physical or logical drives, the one or more events including one or more of a natural disaster, a flood, an earthquake, a tornado, a fire, a cyber-attack, vandalism, electrical-related, mechanical-related, and/or temperature-related issues with respect to the one or more facilities.

18. A non-transitory computer-readable medium configured to store a data distribution program having instructions that enable a processing device to:
receive a command to perform a full backup procedure in which data stored in a structured database managed by a Data Base Management System (DBMS) is intended to be backed up;
programmatically detect, from among a plurality of physical or logical data drives located at one or more data storage facilities, those drives that are currently available for data storage by determining a storage-availability state of each drive; and
based on the detected physical or logical drives and a database-aware data distribution plan generated according to a database schema of the structured database, divide the data stored in the database into multiple data sections corresponding to portions of the structured database and distribute, in a manner that is at least partially in parallel, the multiple data sections to corresponding physical or logical drives to reduce a completion time of the full backup procedure.

19. The non-transitory computer-readable medium of claim 18, wherein distributing the multiple data sections to the physical or logical drives includes storing the multiple data sections in multiple physical or logical drives located at one or more data storage facilities each related to a Backup as a Service (BaaS) facility, a cloud-based data backup repository, and/or an offsite facility.

20. The non-transitory computer-readable medium of claim 18, wherein the database is one of a Structured Query Language (SQL) database, a relational database, and a Very Large Data Base (VLDS), and wherein the data includes at least 1 TB.
